(19) United States
(12) Patent Application Publication
(10) Pub. No.: US 2024/0347834 A1
(43) Pub. Date: Oct. 17, 2024

(54) BATTERY SHELL, TRACTION BATTERY, MOTOR VEHICLE, TOOL FOR PRODUCING A BATTERY SHELL AND METHOD FOR PRODUCING A BATTERY SHELL

(71) Applicant: KAUTEX TEXTRON GmbH & Co. KG, Bonn (DE)

(72) Inventors: Hartmut WOLF, Königswinter (DE); Georg ENKIRCH, Salz (DE); Weiwei ZHAO, Bonn (DE); Bernhard WITSCHEL, Dresden (DE); Achim MERTEL, Dresden (DE); Sebastian MÜNTER, Dresden (DE)

(21) Appl. No.: 18/034,519

(22) PCT Filed: Oct. 18, 2021
(86) PCT No.: PCT/EP2021/078825

§ 371 Date: Apr. 28, 2023

(30) Foreign Application Priority Data
Oct. 29, 2020 (DE) 10 2020 128 527.2

(51) Int. Cl. H01M 50/242; H01M 50/227; H01M 50/231; H01M 50/238; H01M 50/249; H01M 50/262; H01M 50/293

(52) U.S. Cl. CPC H01M 50/242; H01M 50/227; H01M 50/231; H01M 50/238; H01M 50/249; H01M 50/262; H01M 50/293

(57) ABSTRACT

The invention relates to a battery shell comprising at least one inner stiffening means and/or at least one outer stiffening means, which are configured to stiffen the battery shell and to protect a designated battery module from an outer impact. The invention also relates to a traction battery comprising said battery shell and to a motor vehicle comprising said battery shell. Furthermore, the invention relates to a tool for producing this battery shell and a method for producing the battery shell.

This patent application claims the priority of German patent application 2020 128 527.2, the disclosure of which is hereby explicitly referred to.

### TECHNICAL FIELD

The disclosure relates to a battery shell, a traction battery, a motor vehicle, a tool for producing a battery shell, and a method for producing a battery shell.

### BACKGROUND

A battery, in particular a traction battery for storing energy in a motor vehicle, consists of a multiplicity of component parts. One of the tasks of a battery housing comprising at least one battery shell is to fasten and protect battery modules and other required components.

In the case of flat battery housings, in particular battery housings for use in electric vehicles, the requirement for the battery housing is to store the high mass of the battery modules reliably and robustly at comparatively high acceleration values, which is why modern battery housings have a comparatively high mass.

Furthermore, the requirement of a battery of an electric vehicle is that the battery modules are to be protected from damage in the event of any accidents.

### SUMMARY

The object of the invention is that of providing an improvement over or an alternative to the prior art.

According to a first aspect, there is provided a battery shell, in particular a battery shell of a traction battery, the battery shell being formed from plastic material, the battery shell comprising a base and side walls, the battery shell comprising an inner side and an outer side, the battery shell comprising a maximum transverse extension in a transverse direction and a maximum height extension in a vertical direction, the battery shell comprising an inner stiffener, in particular an inner stiffener extending in the transverse direction or a longitudinal direction of the battery shell, in particular an inner stiffener extending in the transverse direction of the battery shell and the longitudinal direction of the battery shell, and/or an outer stiffener, in particular at least one outer stiffener extending in the longitudinal direction of the battery shell.

In this regard, the following is explained conceptually:

First, it should be expressly pointed out that in the context of the present patent application indefinite articles and numbers such as “one,” “two” etc. should generally be understood as “at least” statements, i.e., as “at least one . . . ,” “at least two . . . ” etc., unless it is expressly stated from the relevant context or it is obvious or technically imperative to a person skilled in the art that only “exactly one . . . ,” “exactly two . . . ” etc. can be meant.

In the context of the present patent application, the expression “in particular” is always to be understood in such a way that an optional, preferred feature is introduced with this expression. The expression is not to be understood as “specifically” or “namely.”

A “traction battery” is understood to be an energy storage device, in particular an energy storage device for electrical power. A traction battery is preferably suitable for installation in and for driving electric cars. A traction battery is preferably suitable for use in a battery-electric motor vehicle and/or a motor vehicle having a battery-electric drive and an internal combustion engine.

A “plastics material” is understood to mean a material that mainly consists of macromolecules.

A plastics material is preferably a thermoplastic material, whereby a thermoplastic material is deformable in a material-dependent temperature range, this process being reversible and being repeatable as often as desired by cooling and reheating to the molten state.

A “battery shell” is understood to mean a housing part of a battery, in particular a traction battery.

In particular, a battery shell for receiving components of a battery is configured and accordingly has a receiving space for receiving components so that they can be protected by the battery shell from external influences and/or can be fastened at least indirectly in the battery shell.

Preferably, a battery shell is understood to mean a lower battery shell or an upper battery shell, the lower battery shell and the upper battery shell preferably jointly producing the essential components of the housing of a traction battery.

In particular, a battery shell has a “base” and, in the preferred case of a traction battery with a substantially rectangular outline, at least four “side walls.”

The base and side walls of the battery shell form the receiving volume of a battery shell, the receiving volume of the battery shell describing the “inner side” of the battery shell.

Starting from the receiving volume of the battery shell, the “outer side” of the battery shell is located on the side of the base facing away from the receiving volume and the side walls.

An “inner stiffening means” or “inner stiffener” is understood to mean a geometric configuration of the battery shell on the inner side of the battery shell which is configured to stiffen the battery shell.

Preferably, an inner stiffening means is a rib. A rib is understood to mean a geometry exhibited in the interior of the battery shell and configured to stiffen the battery shell.

Preferably, a rib is a longitudinal rib, where a longitudinal rib extends in the longitudinal direction of the battery shell and is configured to increase at least one area moment of inertia, particularly preferably two area moments of inertia, of a cross section of the battery shell running normal to the longitudinal direction, so that the battery shell is stiffened.

A battery shell can have a square base surface. In this case, a “longitudinal direction” of the battery shell is intended to mean a direction along a side wall of the battery shell, preferably a direction of travel of a designated motor vehicle.

If the battery shell has a base surface that is rectangular or otherwise deviates from a square shape, the longitudinal direction is understood to mean the direction of extension of the at least one side wall of the battery shell which has the longest extension.

In particular, the longitudinal extension direction is parallel to the base of the battery shell.

A “height direction” is understood to mean that direction which runs in the direction of the normal to the plane spanned by the transverse direction and the longitudinal direction.

Preferably, a rib is a transverse rib, wherein a transverse rib extends in the transverse direction of the battery shell and is configured to increase at least one area moment of inertia, particularly preferably two area moments of inertia, of a cross section of the battery shell running normal to the transverse direction, so that the battery shell is stiffened.

Preferably, a rib is arranged such that it is configured as a spatial separation between two designated adjacent battery cells and/or battery modules. Particularly preferably, a battery module can be fastened to an inner stiffening means, further preferably a battery module is carried by an inner stiffening means.

An inner stiffening means preferably has a change in material relative to the battery shell, at least in regions.

Preferably, a layer of an inner stiffening means has a material change relative to the material of the battery shell, preferably in the form of fiber material introduced into the layer, which is preferably configured to increase the stiffness of the cover layer in an extension direction of the cover layer.

A battery shell can have a square base surface. In this case, a “transverse direction” of the battery shell is intended to mean a direction along a side wall of the battery shell.

If the battery shell has a base surface that is rectangular or otherwise deviates from a square shape, the transverse direction is understood to mean the direction of extension transverse to the at least one side wall of the battery shell which has the longest extension.

In particular, the transverse extension direction is parallel to the base of the battery shell.

An inner stiffening means preferably has at least one longitudinal rib and at least one transverse rib. Preferably, the at least one longitudinal rib and the at least one transverse rib are connected to one another.

An “outer stiffening means” or “outer stiffener” is understood to mean a geometric configuration of the battery shell on the outer side of the battery shell and/or a material change of the battery shell which is configured to stiffen the battery shell.

An outer stiffening means is preferably configured to stiffen the base of the battery shell and/or at least one side wall of the battery shell.

Preferably, an outer stiffening means is intended to mean a profile of at least one side wall of the battery shell, wherein the profiling of the at least one profiled side wall of the battery shell increases at least one area moment of inertia of the at least one profiled side wall of the battery shell, particularly preferably two area moments of inertia of the at least one profiled side wall of the battery shell, relative to a side wall of a battery shell without profiling and with comparable wall thickness and comparable material composition.

A profiling is preferably intended to mean an I-profile, a U-profile, a T-shaped profile, a Z-profile, an L-profile, a profile cumulatively composed from the previously mentioned profiles or a deviating profiling.

It should be expressly pointed out that a profiling can be understood to mean any geometric change relative to a planar extension of at least one side wall and/or the base of the battery shell.

Preferably, an outer stiffening means is intended to mean a material change of at least one side wall of the battery shell, wherein the material change of the at least one materially changed side wall of the battery shell increases at least a bending stiffness in relation to a first axis and/or a torsional stiffness of the at least one materially changed side wall of the battery shell, particularly preferably a first bending stiffness relative to a first axis and a second bending stiffness in relation to a second axis of the at least one materially changed side wall of the battery shell compared to a side wall of a battery shell without a material change and with a comparable wall thickness and comparable profile.

A material change to modify an outer stiffening means is intended in particular to mean an addition of fiber material in at least one wall and/or the base of the battery shell, wherein the fiber material is arranged such that it can increase at least one flexural rigidity about a first axis and/or a torsional stiffness, preferably a first bending stiffness relative to a first axis and a second bending stiffness relative to a second axis, of the at least one side wall and/or of the base of the battery.

It should be expressly pointed out that the aspect of an outer stiffening means presented here is not limited to a stiffening of one side wall of the battery shell, rather, also two or more side walls of the battery shell, preferably all side walls of the battery shell, can have an outer stiffening.

It should be expressly pointed out that a side wall can represent a component of an outer stiffening means.

A “transverse extension” is understood to mean the extension of the battery shell in the region of the base in the transverse direction.

A “height extension” is understood to mean the extension of the battery shell in the height direction.

Here, a battery shell made of plastics material, in particular a thermoplastic material, is proposed which has an inner stiffening means and/or an outer stiffening means for stiffening.

Advantageously, the inner stiffening means and/or outer stiffening means proposed here can be used to ensure that the battery shell and the designated traction battery comprising the battery shell, can be protected from a side impact by means of the outer stiffening means.

Further advantageously, the stiffness of the battery shell can be increased by the inner stiffening means and/or the outer stiffening element, and/or the mass of a battery shell can be reduced and material can be saved with the same load-bearing capacity of the battery shell.

According to a particularly preferred embodiment, the battery shell is formed monolithically.

In this regard, the following is explained conceptually:

A “monolithically” formed battery shell is understood to be a battery shell which is produced in a single component in a continuous and seamless manner.

In other words, a monolithically formed battery shell is not composed of multiple individual parts and is also not integrally joined by a plurality of individual parts, for example by means of a welding process. Rather, a monolithically formed battery shell is seamless.

Preferably, a monolithically formed battery shell is understood to be an off-tool battery shell.

An off-tool battery shell is understood to be a battery shell which is produced in one step using a tool.

It can thereby be advantageously achieved that the battery shell together with the inner stiffening means and/or outer stiffening means can be produced cost-effectively in one manufacturing step, the transition from a stiffening means into a side wall and/or the base of the battery shell not having any additional risk of failure due to a weld seam or a different connection.

An inherent tightness of a battery shell can thus also advantageously be achieved.

According to an expedient embodiment, the battery shell is produced by an injection molding process or a pressing process.

In this regard, the following is explained conceptually:

An “injection molding process” is understood to mean a primary shaping process, in which the material to be processed, in particular plastics material, is liquefied by means of an injection molding machine and injected under pressure into a mold, i.e., the injection mold. In the injection mold, the material returns to its solid state as a result of cooling and/or a cross-linking reaction and can be removed as a component part after the injection mold has been opened.

A “pressing process” is understood to mean a primary shaping process in which the molding compound is introduced into the cavity of an associated pressing tool in a first step, with the pressing tool being closed in a second step, in particular using a pressure piston. By closing the pressing tool, the molding compound acquires the shape specified by the pressing tool. The pressing tool is preferably temperature-controlled.

For a molding compound, a thermoplastics material or a thermosetting material which is optionally mixed with a fiber material, in particular glass fiber, carbon fiber, aramid fiber or the like, should be considered.

In particular, a pressing process can also be understood as a direct compounding process (D-LFT), in which a fiber material is fed into an extruder, where it is impregnated with the already melted matrix polymer, in particular a thermoplastics material or a thermosetting material, and is transferred into an injection piston and is then introduced into the pressing tool as a molding compound.

The molding compound preferably has fibers up to a length of 5 mm.

Preferably, the molding compound has fibers having a length of between 0.5 mm and 20 mm, preferably fibers having a length of between 1.0 mm and 15 mm, and particularly preferably fibers having a length of between 1.0 mm and 10 mm, in particular when using an impact extrusion process for producing a battery shell and/or when a battery shell has been produced by means of an impact extrusion process.

Advantageously, an established production process for the battery shell proposed here can thus be used, as a result of which costs can be saved and the process risk of the production process can be minimized.

According to a particularly preferred embodiment of a battery shell comprising at least one inner stiffening means, the at least one inner stiffening means has a core, in particular a structured core, in particular a core in the middle of two cover layers delimiting the core, in particular a structured core comprising a cross rib structure.

In this regard, the following is explained conceptually:

An inner stiffening element, preferably a rib, preferably has a sandwich construction. “Sandwich construction” is understood to mean a combination of different geometries and/or material properties in some regions so that the different regions have different material properties.

In particular, a sandwich construction is understood to mean a planar construction or a substantially planar construction of a stiffening means, the sandwich construction comprising a core which is bordered by two outer layers directly adjacent to the core.

A “core” can be described by it having a lower specific weight compared to the cover layers. Preferably, a core has a particularly high stability in relation to transverse contraction, in particular in relation to a transverse contraction caused by a bending of the stiffening means.

Preferably, a core has a geometry deviating from the cover layers, by means of which the specific properties of the core can advantageously be achieved.

Preferably, a core has a material composition deviating from the cover layers, by means of which the specific properties of the core can advantageously be achieved.

Preferably, the core has a porous material.

Preferably, the core consists of wood, in particular balsa wood.

A “structured core” is understood to mean both a core with a geometry deviating from the cover layers and/or a core with a material composition deviating from the cover layers, a structured core having a structure.

A “cross rib structure” is understood to mean a geometry of a core, where the core has ribs, the respective ends of which preferably form the nodal points of the rib structure.

Preferably, a cross rib structure is configured to divert the compressive forces and/or shear forces that occur in a core into the delimiting cover layers.

Preferably, a structured core, in particular a structured core having a cross rib structure, is formed with a corresponding structural core tool from the inner side of the battery shell and/or from the outer side of the battery shell.

Preferably, ribs are planar or substantially planar.

Preferably, ribs adjacent to each other share only one common nodal point.

Preferably, a cross rib structure has a zigzag pattern.

Preferably, cross ribs, like the diagonals, intersect in a rectangle.

A “cover layer” is understood to mean a material layer which limits a core of a stiffening means in sandwich construction.

Preferably, a cover layer has a material change relative to the material of the battery shell, preferably in the form of fiber material introduced into the cover layer, which is preferably configured to increase the stiffness of the cover layer in an extension direction of the cover layer.

The inner stiffening means proposed here in sandwich construction advantageously enables lightweight construction of an inner stiffening means. Thus, with the same stiffness, weight and material can be saved compared to an inner stiffening means without a sandwich construction. Alternatively, the stiffness of the inner stiffening means can be significantly increased with the same weight.

Particularly preferably, the at least one inner stiffening means of a battery shell has at least one inner stiffening means at least in regions, a layer of a fiber-plastic composite, in particular a layer of a fiber-plastic composite in a first cover layer of an inner stiffening means and/or a layer of a fiber-plastic composite in a second cover layer of an inner stiffening means.

In this regard, the following is explained conceptually:

A “fiber-plastic composite” is understood to mean a crystallized material consisting of oriented fibers and a plastics matrix, the plastics matrix surrounding the fibers and the fibers being bonded to the plastics matrix by adhesive interaction. The fibers are preferably glass fibers, carbon fibers, aramid fibers or the like.

A “layer” of a fiber-plastic composite is understood to mean a layer within the battery shell of a fiber-plastic composite, the layer being delimited by the presence of the fibers that ground the fiber-plastic composite with respect to the regions of the battery shell that are not part of the layer. These regions arranged outside the layer are formed by a molding compound made of plastics material.

Preferably, the molding compound is also used as a plastic matrix for the fiber-plastic composite during the production of the battery shell. However, the molding compound can also itself have fibers, wherein the fibers of the molding compound differ by their length and their arrangement from the fibers in the layer of the fiber-plastic composite; in particular the fibers in the molding compound have a shorter and more chaotic orientation compared to the fibers in the layer of the fiber-plastic composite.

The stiffness of the inner stiffening means can preferably be increased by the layer of a fiber-plastic composite, and/or the weight of the inner stiffening means can be reduced with comparable stiffness.

According to an optional embodiment of a battery shell comprising at least one inner stiffening means, the at least one inner stiffening means has at least one transverse rib.

In this regard, the following is explained conceptually:

A “transverse rib” is understood to mean a slender continuation of the inner stiffening means extending transverse to the main extension direction of the inner stiffening element, which is configured to support the inner stiffening means relative to the base of the battery shell.

Specifically, a plurality of transverse ribs are also conceivable which are arranged at regular or irregular intervals.

Preferably, transverse ribs are arranged in pairs, wherein a transverse rib is preferably formed on both sides of the inner stiffening means with the same value of the longitudinal extension of the inner stiffening means.

Advantageously, a transverse rib or a plurality of transverse ribs contributes to stiffening the base of the battery shell, in particular in the transition region between the base and the inner stiffening means.

According to an optional embodiment of a battery shell comprising at least one inner stiffening means, the at least one inner stiffening means extends over a height of greater than or equal to 30% of the maximum height extension, preferably of greater than or equal to 50% and particularly preferably of greater than or equal to 70%.

Optionally, the at least one inner stiffening means extends over a height of greater than or equal to 40% of the maximum height extension; preferably the at least one inner stiffening means extends over a height of greater than or equal to 60% of the maximum height extension; still more preferably, the at least one inner stiffening means extends over a height of greater than or equal to 80% of the maximum height extension; particularly preferably the at least one inner stiffening means extends over a height of greater than or equal to 90% of the maximum height extension.

Advantageously, the stiffness of the inner stiffening means can thus be optimally adapted to the needs of the battery shell, the amount of the plastics material used also being reducible.

It should be expressly noted that the above values for the height of the inner stiffening means should not be understood as strict limits; rather, it should be possible to exceed or fall below them on an engineering scale without departing from the described aspect. In simple terms, the values are intended to provide an indication of the size of the range proposed here of the height of the inner stiffening means.

According to an optional embodiment of a battery shell comprising at least one outer stiffening means, the at least one outer stiffening means extends over a height of greater than or equal to 30% of the maximum height extension, preferably of greater than or equal to 50% and particularly preferably of greater than or equal to 70%.

Optionally, the at least one outer stiffening means extends over a height of greater than or equal to 40% of the maximum height extension; preferably the at least one outer stiffening means extends over a height of greater than or equal to 60% of the maximum height extension; still more preferably the at least one outer stiffening means extends over a height of greater than or equal to 80% of the maximum height extension; particularly preferably the at least one outer stiffening means extends over a height of greater than or equal to 90% of the maximum height extension.

Advantageously, the stiffness and the material requirement of the outer stiffening means can thus be optimally adapted to the requirements of the battery shell.

It should be expressly noted that the above values for the height of the outer stiffening means should not be understood as strict limits; rather, it should be possible to exceed or fall below them on an engineering scale without departing from the described aspect. In simple terms, the values are intended to provide an indication of the magnitude of the range proposed here of the height of the outer stiffening means.

According to an expedient embodiment of a battery shell comprising at least one outer stiffening means, the at least one outer stiffening means extends over a width of greater than or equal to 5% of the maximum transverse extension, preferably of greater than or equal to 10% and particularly preferably of greater than or equal to 15%.

Optionally, the at least one outer stiffening means extends over a width of greater than or equal to 7.5% of the maximum transverse extent; preferably the at least one outer stiffening means extends over a width of greater than or equal to 12.5% of the maximum transverse extent; still more preferably the at least one outer stiffening means extends over a width of greater than or equal to 17.5% of the maximum transverse extent; particularly preferably the at least one outer stiffening means extends over a width of greater than or equal to 20% of the maximum transverse extension.

Advantageously, the stiffness and the material requirement of the outer stiffening means can thus be optimally adapted to the requirements of the battery shell, in particular to the protection of a battery module from a side impact.

It should be expressly noted that the above values for the width of the outer stiffening means should not be understood as strict limits; rather, it should be possible to exceed or fall below them on an engineering scale without departing from the described aspect. In simple terms, the values are intended to provide an indication of the size of the range proposed here of the width of the outer stiffening means.

An expedient battery shell has at least one outer stiffening means comprising at least two flanges, preferably at least three flanges, the at least two flanges being connected to one another at least indirectly by a spacer element, in particular a web.

In this regard, the following is explained conceptually:

A “flange” is understood to mean a band of an extending profiling geometry. In particular, flanges are understood to mean the bands of an extending profiling geometry, which are kept at a distance by a spacer element, in particular a continuous web, and thus are configured to increase at least one area moment of inertia of an extending profile geometry.

Preferably, a flange is understood to mean the side wall of the battery shell. Here, it is specifically intended that a spacer element, which transitions into a further flange, adjoins the side wall, which forms a flange of the outer stiffening element.

Particularly preferably, an expedient battery shell has at least one outer stiffening means comprising at least one flange.

A “spacer element” is understood to mean any geometry which is configured to hold two flanges extending substantially in a common direction at a distance from one another. Preferably, a spacer element has a rib structure or a cell structure.

Preferably, a spacer is understood to mean a web. A “web” is understood to mean a planar connection between two flanges, preferably between a flange in the form of a side wall of the battery shell and a flange corresponding thereto. Preferably, a web connects adjacent flanges such that the flanges and the web together form an I-profile or a U-profile.

In this way, the stiffness of the at least one outer stiffening element and thus of the battery shell can advantageously be increased.

Particularly preferably, a structured core, in particular a structured core comprising a cross rib structure, is arranged, at least in regions, between two flanges.

It is proposed here to connect adjacent flanges of an outer stiffening element at least in regions by means of a structured core, whereby advantageously a particularly good ratio between the stiffness of the outer stiffening means and the weight of the outer stiffening means can be achieved.

Particularly preferably, the at least one outer stiffening means has, at least in regions, a layer of a fiber-plastic composite, in particular a layer of a fiber-plastic composite in a flange and/or a web.

It can thereby be advantageously achieved that the outer stiffening means can be stiffened by means of the layer of fiber-plastic composite and/or can be designed more easily with the same dimensioning loads.

According to a particularly expedient embodiment, the outer stiffening means has a fastening means, in particular at an intersection point of intersecting cross ribs.

In this regard, the following is explained conceptually:

A “fastening means” or “fastener” is understood to mean anything which is configured to fasten the battery shell to the structure of a designated motor vehicle surrounding the battery shell.

Preferably, a fastening means is formed together with the structured core of an outer stiffening means and is configured without reworking for fastening. Furthermore, it is intended that the fastening means with the shape of the battery shell is already designed as a hollow body. Preferably, the hollow body is configured to receive a threaded bushing.

Advantageously, by means of the arrangement of a fastening means proposed here, any loads can be transmitted directly to a comparatively stiff region of the battery shell, in particular a region which, in the event of a greater deformation in connection with an operating load that may occur, is relatively far away from the battery modules to be protected by the battery shell, whereby any damage from the battery modules can be kept away or at least reduced.

The outer stiffening means particularly preferably has a sealing surface.

In this regard, the following is explained conceptually:

A “sealing surface” is understood to mean a surface which is designed in the form of a contact surface for a sealing means or seal.

Preferably, a sealing surface is planar.

Preferably, a sealing surface has a particularly low surface roughness.

Preferably, a sealing surface is configured to bring about a sealing effect between the battery shell and the corresponding second component in conjunction with a corresponding second sealing surface of a corresponding second component, in particular a corresponding battery cover or a corresponding second battery shell, and a corresponding sealing means, in particular in the presence of an effective normal force between the battery shell and the corresponding second component.

It can advantageously be achieved by the sealing surface that a designated traction battery comprising a battery shell with a sealing surface can have a particularly good and robust seal between the battery shell and a second battery shell or a battery cover.

According to an expedient embodiment, the outer stiffening means has a support region.

In this regard, the following is explained conceptually:

A “support region” is understood to mean part of the geometry of an outer stiffening means which is configured as a contact surface between the battery shell and the motor vehicle designated to surround the battery shell.

A centering of the battery shell in a designated motor vehicle can advantageously be achieved by the support region, whereby the assembly and maintenance of a designated traction battery can be simplified. In addition, the support region can also transmit loads from the motor vehicle to the battery shell and from the battery shell to the motor vehicle by means of a positive fit with the designated adjoining region of the motor vehicle.

Particularly preferably, the at least one layer of a fiber-plastic composite has fibers oriented substantially unidirectionally to one another.

The unidirectional arrangement of the fibers makes it possible to further increase the stiffness at the location of the layer of fiber-plastic composite, at least if the load direction of an inner tension has a component in the direction of the orientation of the fibers.

According to a particularly expedient embodiment, the inner stiffening means engages in the outer stiffening means.

It is proposed here that the structural configuration of an inner stiffening means extends at least in regions through the outer stiffening means.

Advantageously, the transition region between an inner stiffening means and an outer stiffening means can thus be additionally stiffened.

According to a particularly expedient embodiment, an outer stiffening means and an inner stiffening means engage in each other. In other words, a battery shell has at least one outer stiffening means and at least one inner stiffening means, the outer stiffening means and the inner stiffening means having a common penetration region so that at least one of the stiffening means extends into the other stiffening means.

Advantageously, the stiffness of the battery shell can thereby be increased with respect to complex load cases.

According to a second aspect, there is provided a traction battery, in particular a traction battery for a motor vehicle comprising a battery shell according to the first aspect.

In this regard, the following is explained conceptually:

A “motor vehicle” is understood to mean a vehicle driven by a motor. A motor vehicle is preferably not mounted on a rail or at least not permanently track-mounted.

It should be understood that the advantages of a battery shell according to the first aspect, as described above, extend directly to a traction battery comprising a battery shell according to the first aspect.

It should be expressly noted that the subject matter of the second aspect can advantageously be combined with the subject matter of the preceding aspect, both individually or cumulatively in any combination.

According to a third aspect, there is provided a motor vehicle comprising a battery shell according to the first aspect and/or a traction battery according to the second aspect.

It should be understood that the advantages of a battery shell according to the first aspect, as described above, and/or a traction battery according to the second aspect, extend directly to a motor vehicle comprising a battery shell according to the first aspect and/or a traction battery according to the second aspect.

It should be expressly noted that the subject matter of the third aspect can advantageously be combined with the subject matter of the preceding aspects, both individually and cumulatively in any combination.

According to a fourth aspect, there is provided a tool for producing a battery shell made of plastics material comprising an inner stiffening means and/or an outer stiffening means, in particular a battery shell according to the first aspect, the tool forming an article cavity and the tool having a means for filling the article cavity with a molding compound made of plastics material.

In this regard, the following is explained conceptually:

A “tool” is understood to mean a device for primary shaping, in particular for primary shaping of a battery shell according to the first aspect from a molten molding compound.

A tool is preferably understood to mean an injection mold.

A tool is preferably understood to mean a pressing tool.

A tool is preferably understood to mean a dipping edge tool.

An “article cavity” is understood to mean the hollow space which is formed by a tool for forming regions of the component that is designated to be produced with the tool, in particular a battery shell.

A “means for filling” or “filler” is understood to mean a device which is indirectly or directly assigned to the tool and is configured to introduce a molten molding compound into the tool.

Preferably, a means for filling is understood to mean a device which is configured to fill the article cavity of the tool and/or the tool cavity of the tool with a molten molding compound, in particular in connection with an injection mold and/or an injection molding device.

Preferably, a means for filling is understood to mean a device by means of which a molten molding compound can be introduced, in particular can be inserted, into a previously opened tool, in particular in conjunction with a pressing tool and/or a pressing device.

Here, a tool for producing a battery shell according to the first aspect is proposed.

It should be understood that the previously explained advantages of a battery shell according to the first aspect extend to a tool for producing a battery shell according to the first aspect.

According to a particularly preferred embodiment, the tool has at least one structural core tool, in particular at least one cross rib tool, which is configured for forming a structured core, in particular for forming a structured core having a cross rib structure.

In this regard, the following is explained conceptually:

A “structural core tool” is understood to mean an optional component of the tool for forming a battery shell, the structural core tool being configured to form a structured core of an inner stiffening means and/or an outer stiffening means.

Preferably, a structural core tool can be moved relative to the adjacent region of the tool for forming the battery shell, in particular in a translational direction.

A “cross rib tool” is understood to mean a structural core tool which is configured for forming a cross rib structure in the core of an inner stiffening means and/or an outer stiffening means.

This advantageously allows the battery shell to have a region with a structured core, in particular a core having cross ribs and/or a separation region.

It should be understood that the above-explained advantages of a battery shell comprising a structured core and/or a separation region in the region of an inner stiffening means and/or an outer stiffening means extend directly to a tool for producing a battery shell comprising a structured core in the region of an inner stiffening means and/or an outer stiffening means.

According to an expedient embodiment, the tool has at least one clamp or means for clamping a fiber material, in particular a shock-frozen fiber material and/or a fiber material melted on the edge layers.

In this regard, the following is explained conceptually:

“Clamping” is understood to mean a fastening, in particular a releasable fastening of a fiber material, in particular of a shock-frozen fiber material and/or of a fiber material melted on the edge layers, in a tool.

In particular, it is intended here to provide a means for clamping which clamps the fiber material as long as it is not saturated completely by the molding compound. Preferably, the means proposed here for clamping is configured such that it is displaced by the molding compound as soon as the molding compound reaches the means for clamping with the necessary pressure of the molding compound. As a result, it can advantageously be achieved that the means for clamping the fiber material clamps as long as necessary.

Among other things, it is proposed here that a fiber material is melted partially or completely on the edge layers, while the core of the fiber material is still surrounded by a crystalline matrix so that the fiber material still has an inherent stiffness while it is being clamped by a means in the tool.

A fiber material melted only in its edge regions with a core having a crystalline matrix and/or a soft-frozen fiber material can advantageously be easily gripped and positioned by a robot.

Advantageously, a battery shell can thus be produced which has a fiber material in the region of an inner stiffening means and/or an outer stiffening means, whereby the stiffness of the battery shell can be increased.

It should be expressly noted that the subject matter of the fourth aspect can advantageously be combined with the subject matter of the preceding aspects, both individually and cumulatively in any combination.

According to a fifth aspect, there is provided a method for producing a battery shell made of plastics material comprising an inner stiffening means and/or an outer stiffening means, in particular a battery shell according to the first aspect, by means of an injection molding device or a pressing device with a tool forming an article cavity, in particular a tool according to the fourth aspect, comprising means for filling the article cavity with a molding compound made of plastics material, the production method comprising the following steps:
a) filling the article cavity with a molding compound made of plastics material;
b) demolding the battery shell.

In this regard, the following is explained conceptually:

According to a first variant, a “filling” is understood to mean that an injection mold is filled indirectly by an extruder or completely filled directly with a molten molding compound.

According to a second variant, a “filling” is understood to mean that a pressing tool with a molding compound is loaded indirectly or directly by an extruder and then the molding compound is distributed in the article cavity by the stroke of the pressing tool, so that the article cavity is filled with the molding compound.

“Demolding” should be understood as the removal of the battery shell designated to be produced according to the first aspect from the tool.

“Forming” should be understood to mean any shaping of a body by means of which a three-dimensional form can be achieved, in particular a three-dimensionally formed battery shell.

Forming should preferably be understood to mean forming by means of an injection molding process.

Forming should preferably be understood to mean forming by means of a compression molding process or an impact extrusion process. In this case, a molding compound is introduced into a cavity of a die, the die having been heated or is being heated and/or cooled. The cavity is then closed using a pressure piston. The pressure gives the molding material the shape specified by the cavity and pressure piston.

Here, a method for producing a battery shell according to the first aspect is proposed, the battery shell being formed according to the first aspect by means of a molding compound by a tool forming an article cavity. In this case, it is possible, inter alia, to use an injection molding process or a pressing process, in particular a pressing process by means of a dipping edge tool.

It should be understood that the advantages of a battery shell according to the first aspect extend to a method for producing a battery shell according to the first aspect.

According to a particularly expedient embodiment, the tool forming the article cavity is provided with a fiber material, in particular a shock-frozen fiber material, before the article cavity is filled with the molding compound made of plastics material.

It is now specifically proposed here first to introduce the fiber material for a layer made of a fiber-plastic composite located in the designated component into the mold, in particular in a shock-frozen and thus dimensionally stable state.

It can thus advantageously be gripped and positioned by a robot. When the battery shell is molded, the molding compound flows around the previously introduced fiber material and partially flows through it, as a result of which the layer is formed from a fiber-plastic composite.

Alternatively, it is specifically proposed that the fiber material for a layer of a fiber-plastic composite that is located in the designated component initially be melted at least partially or completely on its edge layer while the core of the fiber material still has a crystalline matrix and subsequently be introduced into the mold. Due to the crystalline matrix, the fiber material has a preferably inherent stiffness so that it can advantageously be gripped and positioned by a robot.

It should be expressly noted that the subject matter of the fifth aspect can advantageously be combined with the subject matter of the preceding aspects, both individually and cumulatively in any combination.

### DESCRIPTION OF THE DRAWINGS

Further advantages, details and features can be found below in the described embodiments. In the drawings, in detail:

FIG. 1: schematically shows a detail of an embodiment of a battery shell;

FIG. 2: schematically shows a detail of a further embodiment of a battery shell;

FIG. 3: schematically shows a detail of a further embodiment of a battery shell;

FIG. 4: schematically shows a detail of a further embodiment of a battery shell;

FIG. 5: schematically shows a detail of a further embodiment of a battery shell;

FIG. 6: schematically shows a detail of a further embodiment of a battery shell;

FIG. 7: schematically shows a detail of a further embodiment of a battery shell;

FIG. 8: schematically shows a detail of a further embodiment of a battery shell;

FIG. 9: schematically shows a detail of a further embodiment of a battery shell; and

FIG. 10: schematically shows a detail of a further embodiment of a battery shell.

### DETAILED DESCRIPTION

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

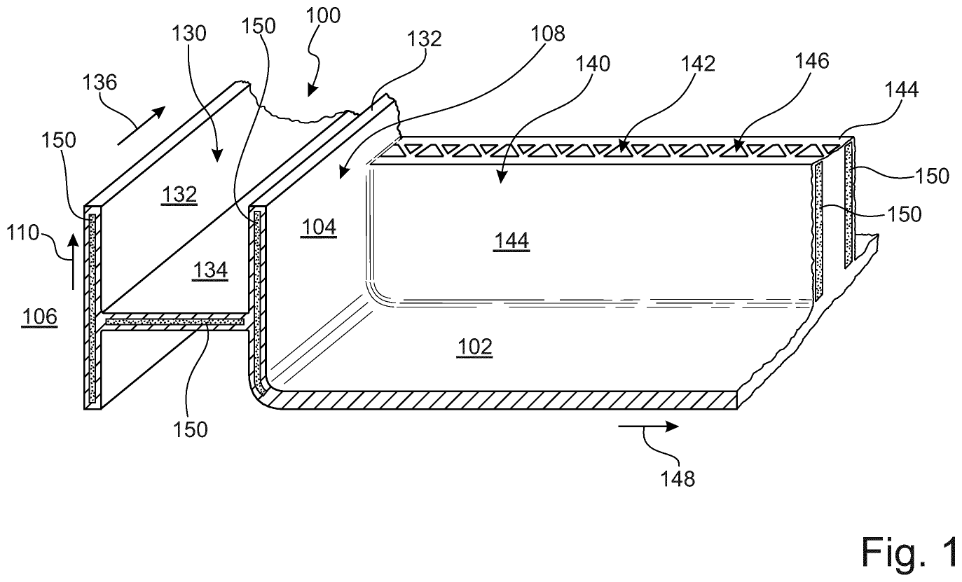

The detail of an embodiment of a monolithically formed battery shell 100 in FIG. 1 has a battery shell 100 consisting of a base 102, at least one side wall 104, an outer stiffening means 130 and an inner stiffening means 140, the battery shell 100 having an inner side 108, an outer side 106 and a height direction 110.

The outer stiffening means 130 extends in a longitudinal direction 136 of the battery shell 100 and consists essentially of two flanges 132, one of the flanges 132 coinciding with the side wall 104 of the battery shell 100, a spacer element 134, which keeps the flanges 132 at a distance from one another even under load and associated deformation, so that they provide a significant contribution to at least one area moment of inertia of the battery shell 100.

The inner supporting element 140 extends in a transverse direction 148 of the battery shell 100 and consists essentially of two cover layers 144, which are arranged around a core 142, in particular a structured core 142, comprising a cross rib structure 146.

The inner stiffening means 140 and the outer stiffening means 130 each have a layer 150 of fiber-plastic composite at different locations, whereby the battery shell 100 can be designed to be stiffer and/or lighter.

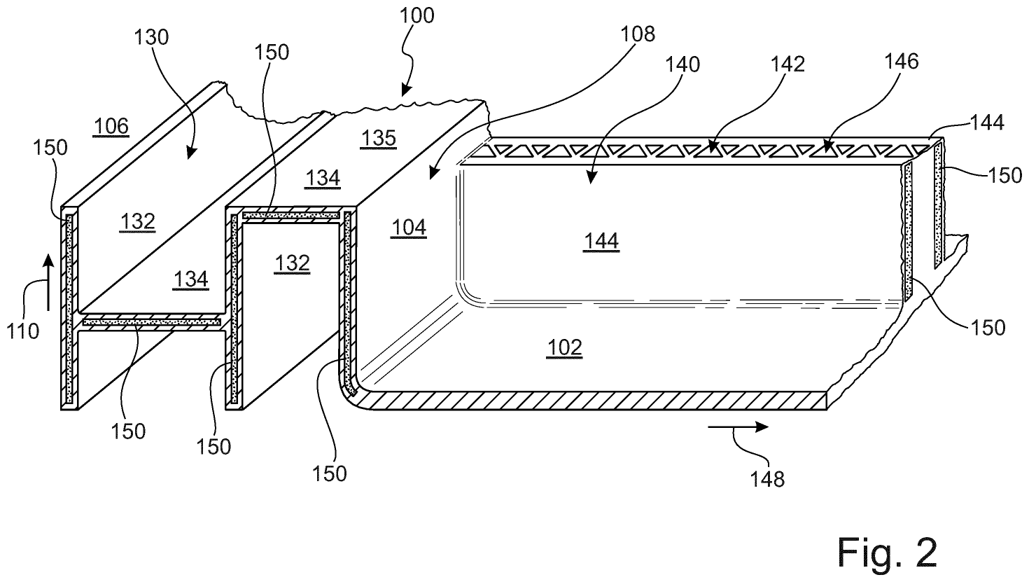

The embodiment of a battery shell 100 in FIG. 2 has a different embodiment of an outer stiffening means 130.

Thus, the outer stiffening means 130 has a total of three flanges 132, one of which coincides with the side wall 104 of the battery shell 100.

The outer flanges 132 are connected by means of a spacer 134, which is arranged at half the height in the height direction 110 of the battery shell 100.

The two inner flanges 134 are also connected to a spacer element 134, this spacer element 134 being arranged at the location with the greatest height extension (not indicated) of the outer stiffening means 130, and this inner spacer element 134 having a sealing surface 135 on its upper side, which sealing surface is configured for sealing with a corresponding battery shell (not shown).

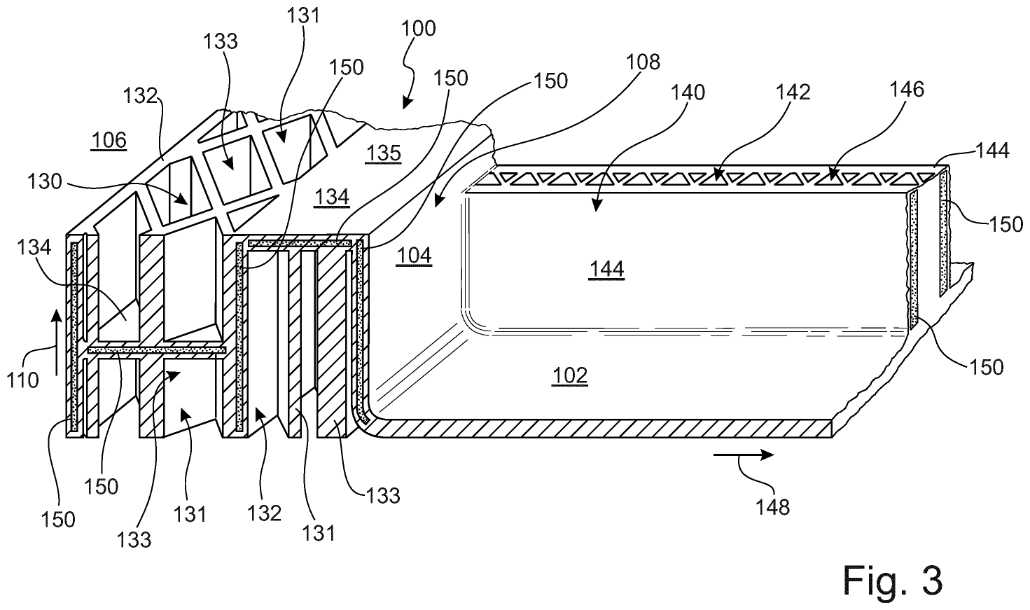

A further embodiment of a battery shell 100 in FIG. 3 has between the flanges 132 of the outer stiffening means 130 different regions of structured cores 131, in particular of structured cores 131 comprising a cross rib structure 133, which connect the flanges 132 next to the spacer elements 134 and enable the outer stiffening means 130 to provide additional stiffness or a reduced weight.

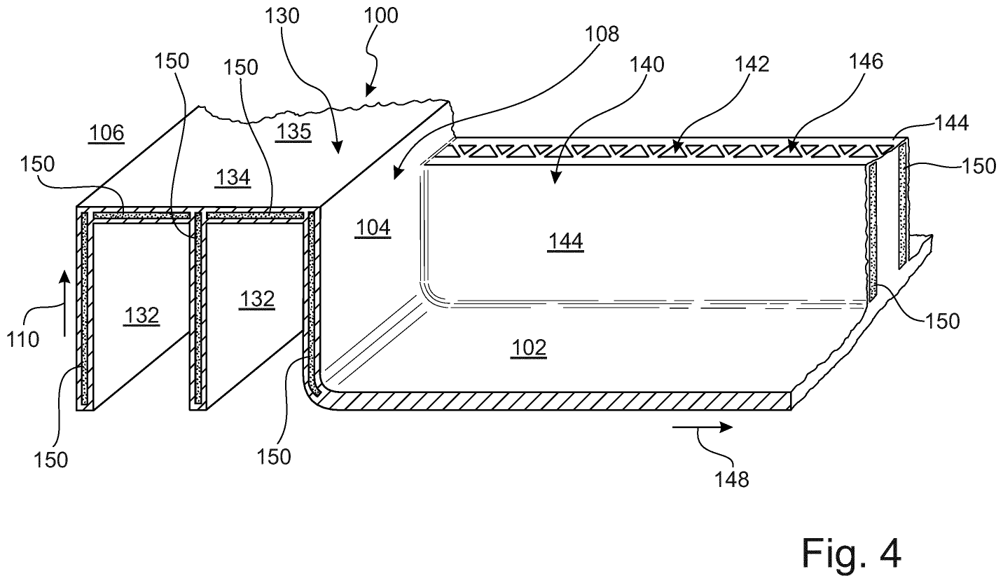

Further embodiment of a battery shell 100 in FIG. 4 has two spacer elements 134 between the flanges 132 of the outer stiffening means 130, the spacer elements 134 being arranged at the location with the greatest height extension (not indicated) of the outer stiffening means 130. They have a sealing surface 135 on their upper side.

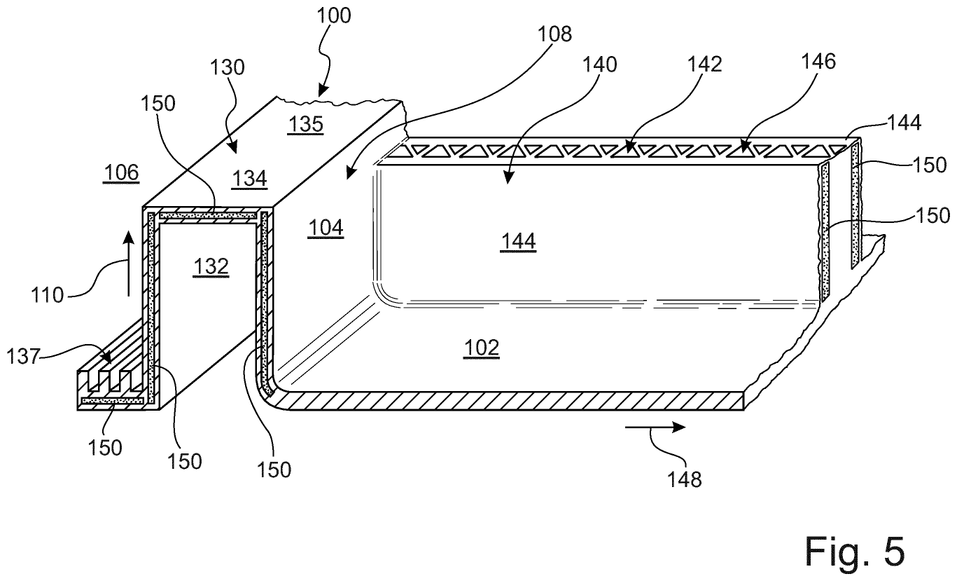

The embodiment of a battery shell 100 in FIG. 5 has a support region 137, which is configured for contacting and/or centering the battery shell 100. Preferably, the support region 137 is arranged seamlessly around the battery shell 100.

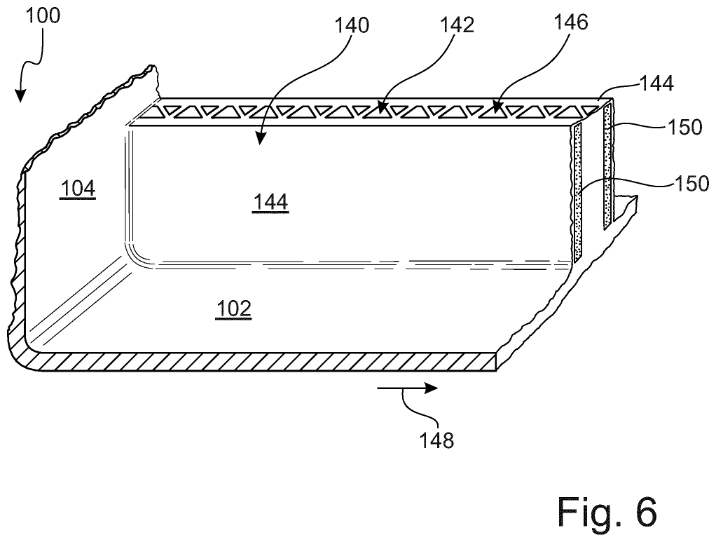

In the embodiment of a battery shell 100 in FIG. 6, the outer stiffening means (not shown) has been cut away when the cutout is selected.

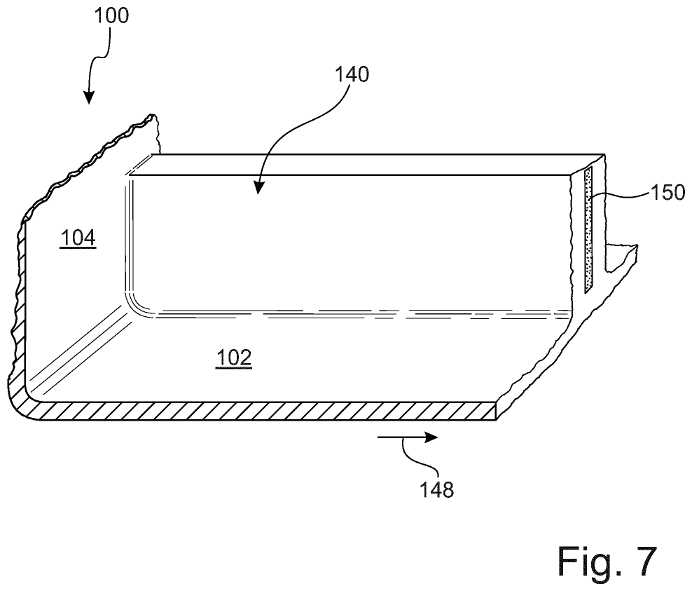

Further embodiment of a battery shell 100 in FIG. 7 has an inner stiffening means 140 configured differently. The inner stiffening means 140 does not have a central structured core, but also via a layer 150 of a fiber-plastic composite, which preferably extends over the height of the inner stiffening element 140.

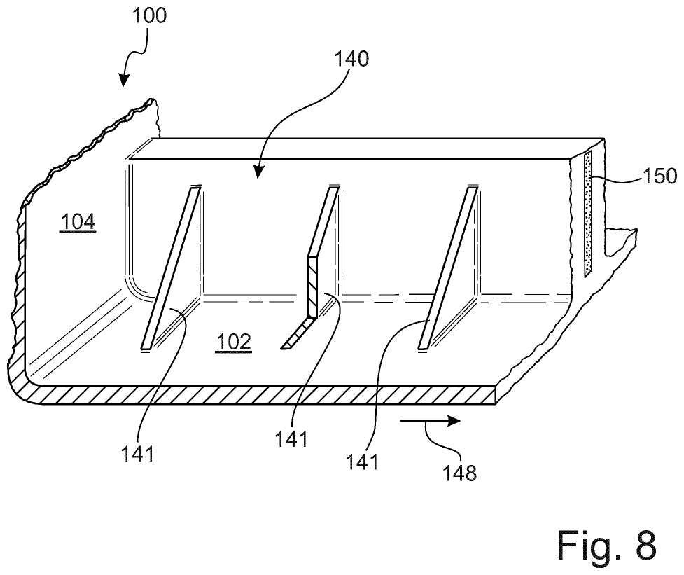

Further embodiment of a battery shell 100 in FIG. 8 has a plurality of transverse ribs 141 for further stiffening the inner stiffening means 140.

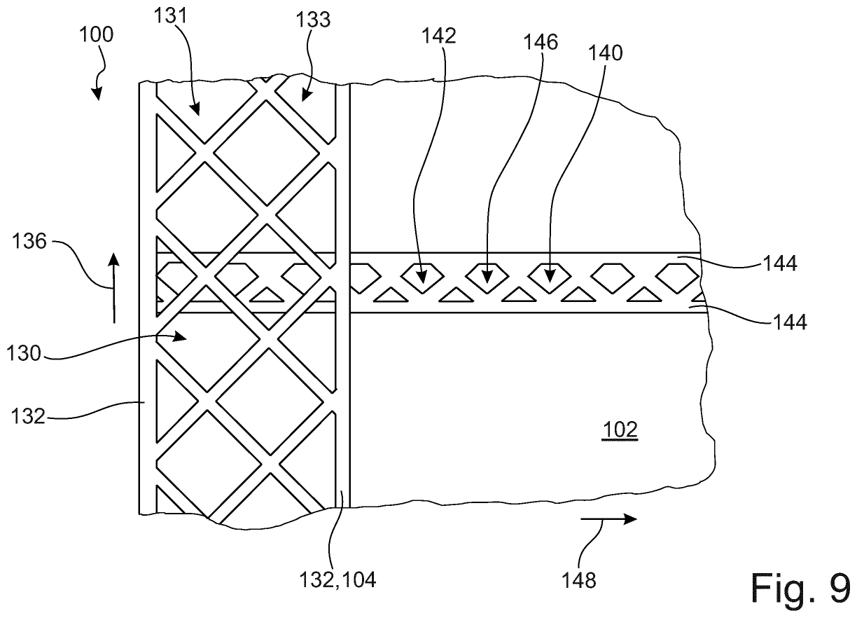

In a further embodiment of a battery shell 100 in FIG. 9, an outer stiffening means 130 and an inner stiffening means 140 engage one another, the shapes of the structured cores 131, 142 being adapted to one another so that the greatest possible additional stiffening of the battery shell 100 can be achieved.

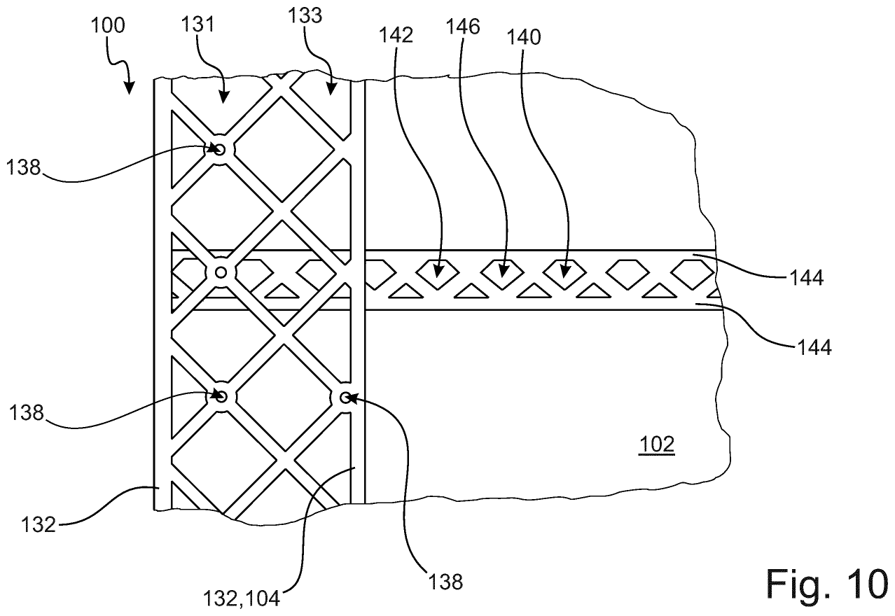

One embodiment of a battery shell 100 in FIG. 10 comprises a plurality of fastening means 138, by means of which the battery shell 100 can be connected to the motor vehicle.

It is to be understood that the foregoing is a description of one or more preferred exemplary embodiments of the invention. The invention is not limited to the particular embodiment(s) disclosed herein, but rather is defined solely by the claims. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

100 battery shell
102 base
104 side wall
106 outer side
108 inner side
110 height direction
130 outer stiffening means or outer stiffener
131 core, structured core
132 flange
133 cross rib structure
134 spacer element, web
135 sealing surface
136 longitudinal direction
137 support region
138 fastening means
140 inner stiffening means, inner stiffener, rib
141 transverse rib
142 core, structured core
144 top layer
146 cross rib structure
148 transverse direction
150 layer of a fiber-plastic composite

1. A battery shell of a traction battery, the battery shell being made of plastic, the battery shell comprising a base and side walls, the battery shell comprising an inner side and an outer side, the battery shell comprising a maximum transverse extension in a transverse direction and a maximum height extension in a height direction, characterized in that
the battery shell comprises an inner stiffener extending in the transverse direction or a longitudinal direction of the battery shell, and/or
an outer stiffener extending in the longitudinal direction of the battery shell.

2. The battery shell according to claim 1, characterized in that the battery shell is monolithically formed.

3. The battery shell according to claim 1, characterized in that the battery shell is produced using an injection molding method or a pressing method.

4. The battery shell according to claim 1, characterized in that the inner stiffener has a structured core.

5. The battery shell according to claim 1, characterized in that the inner stiffener has, at least in regions, a layer of a fiber-plastic composite.

6. The battery shell according to claim 1, characterized in that the inner stiffener includes at least one transverse rib.

7. The battery shell according to claim 1, characterized in that the inner stiffener extends over a height of greater than or equal to 30% of the maximum height extension.

8. The battery shell according to claim 1, characterized in that the outer stiffener extends over a height of greater than or equal to 30% of the maximum height extension.

9. The battery shell according to claim 1, characterized in that the outer stiffener extends over a width of greater than or equal to 5% of the maximum transverse extent.

10. The battery shell according to claim 1, characterized in that the outer stiffener has at least two flanges connected to one another at least indirectly by a spacer element.

11. The battery shell according to claim 10, characterized in that a structured core is arranged between the at least two flanges, at least in regions.

12. The battery shell according to claim 10, characterized in that the outer stiffener has, at least in regions, a layer of a fiber-plastic composite.

13. The battery shell according to claim 1, characterized in that the outer stiffener has a fastener.

14. The battery shell according to claim 1, characterized in that the outer stiffener comprises a sealing surface.

15. The battery shell according to claim 1, characterized in that the outer stiffener comprises a resting region.

16. The battery shell according to claim 1, the battery shell comprising at least one layer of a fiber-plastic composite characterized in that the at least one layer of a fiber-plastic composite comprises fibers oriented substantially unidirectionally to one another.

17. The battery shell according to claim 1, the battery shell comprising an inner stiffener and an outer stiffener, characterized in that the inner stiffener engages in the outer stiffener.

18. A traction battery for a motor vehicle, comprising the battery shell according to claim 1.

19. A motor vehicle comprising the battery shell according to claim 1.

20. A tool for producing the battery shell of according to claim 1, the tool forming an article cavity and being configured for filling the article cavity with a molding compound made of plastic material.

21. The tool according to claim 20, characterized in that the tool comprises at least one structural core tool which is configured to form a structured core.

22. The tool according to claim 20, characterized in that the tool has at least one clamp for clamping a fiber material.

23. A method for producing a battery shell according to claim 1 using an injection molding device or a pressing device with a tool forming an article cavity, the method comprising the following steps:
a) filling the article cavity with a molding compound made of plastic material;
b) demolding the battery shell.

24. The method according to claim 23, characterized in that the tool forming the article cavity is equipped with a fiber material before the article cavity is filled with the molding compound made of plastic material.
